(19) United States
(12) Patent Application Publication
(10) Pub. No.: US 2012/0159327 A1
(43) Pub. Date: Jun. 21, 2012

(54) REAL-TIME INTERACTION WITH ENTERTAINMENT CONTENT

(75) Inventors: Stacey Wing Yin Law, Redmond, WA (US); Kevin Casey Gammill, Beaux Arts, WA (US); Alex Garden, Bellevue, WA (US); Scott Porter, Sammamish, WA (US)

(73) Assignee: MICROSOFT CORPORATION, Redmond, WA (US)

(21) Appl. No.: 12/969,917

(22) Filed: Dec. 16, 2010

(51) Int. Cl. G06F 3/01

(52) U.S. Cl. 715/716

(57) ABSTRACT

A system allows users to interact with traditionally one-way entertainment content. The system is aware of the interaction and will behave appropriately using event data associated with the entertainment content. The event data includes information for a plurality of events. Information for an event includes references to software instructions and audio/visual content items used by the software instructions. When an event occurs, the software instructions are invoked. This system may be enabled over both recorded content and live content, as well as interpreted and compiled applications.

### BACKGROUND

Traditionally, entertainment experiences such as listening to music, watching movies or watching television are one-way experiences. Content is played while the audience sits back and experiences it. There's no way to interact with the content other than to fast-forward or rewind the content.

### SUMMARY

A system is provided that allows users to interact with traditionally one-way entertainment content. The system is aware of the interaction and will behave appropriately using event data associated with the entertainment content. The event data includes information for a plurality of events. Information for an event includes software instructions and/or references to software instructions, as well as audio/visual content items used by the software instructions. When an event occurs, the user is provided an alert about the event through a number of possible mechansims. If the user responds to (or otherwise interacts with) the alert, then the software instructions for the event are invoked to provide an interactive experience. This system may be enabled over both recorded and live content.

One embodiment includes a method for providing interaction with a computing system. That method comprises accessing and displaying a program using the computing system, identifying event data associated with the program where the event data includes data for a plurality of events and the data for the events includes references to software instructions and audio/visual content items, automatically determining that a first event has occurred, providing a first alert for the first event, receiving a user interaction with the first alert, programming the computing system using the software instructions and audio/visual content items associated with the first event in response to receiving the user interaction with the first alert, automatically determining that a second event has occurred, providing a second alert for the second event, receiving a user interaction with the second alert, and programming the computing system using the software instructions and audio/visual content items associated with the second event in response to receiving the user interaction with the second alert. The software instructions and audio/visual content items associated with the second event are different than the software instructions and audio/visual content items associated with the first event.

One embodiment includes non-volatile storage that stores code, a video interface, a communication interface and a processor in communication with the non-volatile storage, the video interface and the communication interface. A portion of the code programs the processor to access content and event data for a plurality of events that are associated and time synchronized with the content. The content is displayed via the video interface. The processor displays a linear time display that indicates a temporal location in the content and adds event indicators on the linear time display identifying time in the content for each event. The event indicator may also indicate the type of content to be displayed at that temporal location (e.g., shopping opportunity, more info, user comments, etc.) The processor plays the content and updates the linear time display to indicate current temporal location of the content. When current temporal location of the content is equivalent to a temporal location of a particular event indicator then the processor provides a visible alert for the particular event associated with the particular event indicator. If the processor does not receive a response to the visible alert then the processor removes the visible alert without providing additional content associated with the visible alert. If the processor receives the response to the visible alert then the processor runs software instructions associated with the visible alert identified by event data associated with the particular event indicator. Running the software instructions associated with the visible alert includes providing choices to perform any one of a plurality of functions. Alerts or events are stored and can be retrieved at a later time if desired by the individual consuming the content. Additionally, one could just view the alerts without consuming the content (dynamic events not included).

One embodiment includes one or more processor readable storage devices having processor readable code stored thereon. The processor readable code is for programming one or more processors to perform a method comprising identifying two or more users concurrently interacting with a first computing system, accessing and displaying an audio/visual program using the first computing system, identifying event data associated with the audio/visual program where the event data includes data for a plurality of events and the data for the events includes references to software instructions and audio/visual content items, automatically determining that an event has occurred, sending a first set of instructions to a second computing system based on user profile data associated with one of the two or more users identified to be concurrently interacting with the first computing system, sending a second set of instructions to a third computing system based on user profile data associated with another of the two or more users identified to be concurrently interacting with the first computing system. The first set of instructions provide for the second computing system to display first content. The second set of instructions provide for the third computing system to display second content different than the first content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-C depict a user interface.

FIG. 2 depicts user interfaces for three devices.

FIG. 3 is a block diagram depicting various components of a system for providing interactive content.

FIG. 4 depicts an example entertainment console and tracking system.

FIG. 5 illustrates additional details of one embodiment of the entertainment console and tracking system.

FIG. 6 is a block diagram depicting the components of an example entertainment console.

FIG. 7 is a block diagram of software components for one embodiment of a system for providing interactive content.

FIG. 8 is a symbolic and abstract representation of a layer that can be used in one embodiment of a system for providing interactive content.

FIG. 9 depicts the hierarchical relationship among layers.

FIG. 10 provides an example of code defining a layer.

FIGS. 11A and 11B provide a flow chart describing one embodiment of a process for providing interactive content.

FIG. 12 provide a flow chart describing one embodiment of a process for invoking code pointed to for an event.

FIG. 13 provide a flow chart describing one embodiment of a process for invoking code pointed to for an event when multiple users are interacting with companion devices.

FIG. 14 provide a flow chart describing one embodiment of a process for receiving a stream of data.

FIG. 15 provide a flow chart describing one embodiment of a process for receiving layers during live programming

FIG. 16 provide a flow chart describing one embodiment of a process for creating events during a game.

### DETAILED DESCRIPTION

A system is proposed that allows users to interact with traditionally one-way entertainment content. When playing entertainment content (such as an audio/visual program or computer based game), event data is used to provide interaction with the entertainment content. An event is something that happens in or during the entertainment content. For example, an event during a television show can be the presence of the credits, playing of a song, start of a scene, appearance of an actress, appearance of an item or location, etc. The entertainment content may be associated with multiple events; therefore, the event data includes information for the multiple of events associated with the entertainment content. Information for an event includes software instructions and/or references to software instructions, as well as audio/visual content items used by the software instructions. When an event occurs, the user is provided an alert about the event. If the user responds to (or otherwise interacts with) the alert, then the software instructions for the event are invoked to provide an interactive experience.

Features of the technology described herein include that the event data can provide different types of content (e.g., images, video, audio, links, services, etc.), is modular, optionally time synchronized, optionally event triggered, hierarchical, filterable, capable of being turned on/off capable of being created in different ways by different sources and combinable with other event data. These features of the event data allow the computing system being interacted with to be dynamically programmed on the fly during the presentation of the entertainment content such that the interactive experience is a customizable and dynamic experience. This system may be enabled over both recorded content and live content, as well as interpreted and compiled applications.

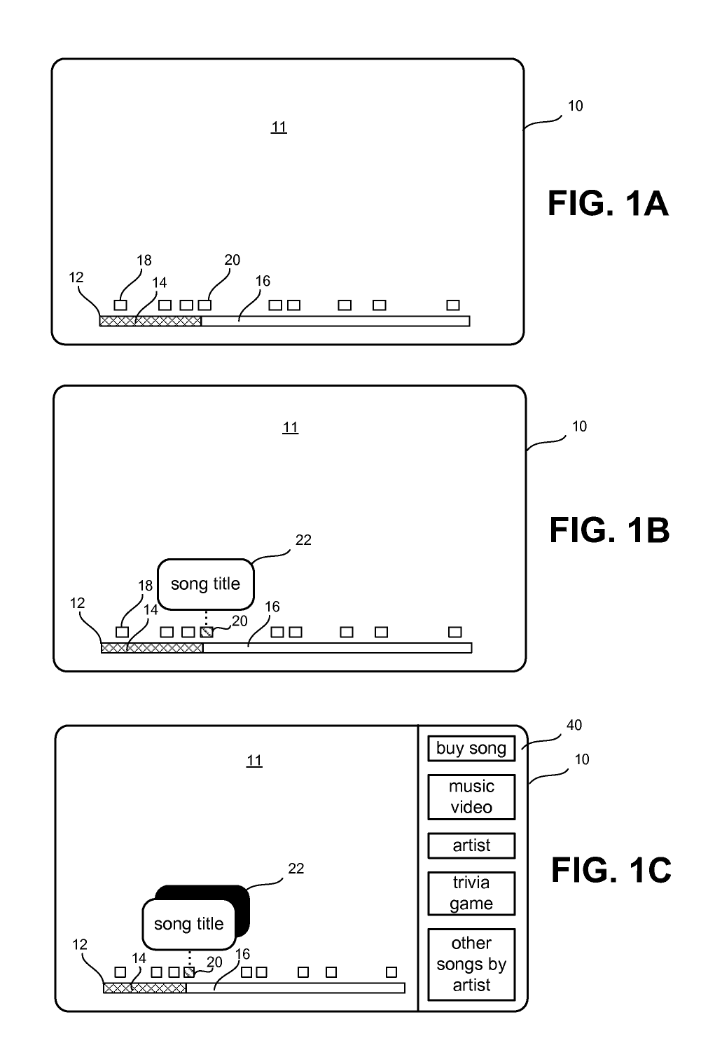

FIG. 1 shows a user interface 10 depicting one example of interacting with entertainment content (or other types of content). In one embodiment, interface 10 is a high definition television, computer monitor, or other audio/visual device. or for purposes of this document, audio/visual shall include audio only, visual only or a combination of audio and visual. Region 11 of interface 10, in this example, is playing (or otherwise displaying) an audio/visual program which is one example of content that can be interacted with. Types of content can also be presented and interacted with include, for example, a television show, a movie, other type of video, still images, slides, audio presentation, games, or other content or application. The technology described herein is not limited to any type of content or application.

At the bottom of interface 10 is a timeline 12, which is one example of a linear time display. Timeline 12 indicates the current progress into the program being presented on interface 10. Shaded portion 14 of timeline 12 indicates that portion of the content that has already been presented and unshaded portion 16 of timeline 12 indicates that portion of the content that has not been presented yet. In other embodiments, different types of linear time displays can be used or other graphical mechanisms for displaying progress and relative time can be used that are not linear. Immediately above timeline 12 are a set of event indicators, which appear as square boxes. Event indicators can be other shapes. For example purposes, FIG. 1A shows nine event indicators disbursed over different portions of timeline 12. Two of the event indicators are marked by reference numerals 18 and 20. Each event indicator corresponds to an event that can occur in or during the program being presented. Each event indicator' position along timeline 12 indicates a time that the associated event will occur. For example, event indicator 18 may be associated with a first event and event indicator 20 can be associated with a fourth event. As an example, the first event may include the first appearance of a particular actor and the fourth event may be the playing of a particular song during the program. A user of the computing system viewing a program on interface 10 will see from timeline 12 and the event indicators when during the program various events will occur. Note that in some embodiments the timeline and event indicators are not displayed. In other embodiments, the timeline and event indicators are only displayed right before an event is to occur. In another embodiment, the timeline and event indicators are displayed on demand from the user (e.g., via remote control or using a gesture).

FIGS. 1B and 1C illustrate one example of an interaction with the content being displayed in region 11 of interface 10. Note that the actual content being displayed is not depicted in FIGS. 1A-1C in order to not clutter up the drawing. The point along timeline 12 in which shaded area 14 meets unshaded area 16 represents the current temporal location of the content (e.g., the relative time into the TV program or movie, etc.). When the current temporary location of the content being presented on interface 10 is equal to the temporal location of a particular event (e.g., the elapsed time of the movie equals the time associated with the event), then an alert is provided. For example, FIG. 1B shows a text bubble 22 (the alert) popping up from event indicator 20. In this example, the event is a song being played during a television show or movie. The text bubble may indicate the title of a song. In other embodiments, the alert can include audio only, audio with the text bubble, or other user interface components that can display text or images. Alerts can also be provided on companion electronic devices, as will be described below.

The technology described herein isn't required to be based on temporal location. If the system uses metadata triggers or event triggers (e.g., in a game which is a non-linear experience), events may be triggered if some sequence of events has been met and not via a temporal marker.

Once the user is provided with the alert, the user has a period of time in which to interact with the alert. If the user does not interact with the alert during that predetermined period of time, then the alert is removed. If the user does interact with the alert, then the user is provided with additional content to interact with.

There are many ways to interact with an alert. In one embodiment, the user can use hand gestures (as explained below), a mouse, a different pointing device, voice or other means in order to select, choose, acknowledge or otherwise interact with the alert.

FIG. 1C depicts interface 10 after the user has interacted with or otherwise acknowledged the alert. As can be seen, text bubble 22 now shows a shadowing to provide visual feedback to the user that the user's interaction is acknowledged. In other embodiments, other graphical acknowledgements and/or audio acknowledgements can be used. In some embodiments, no acknowledgement is necessary. In response to the user interacting with the alert, additional content is provided in region 40 of interface 10. In one embodiment, region 11 is made smaller to fit region 40. In another embodiment, region 40 overlies region 11. In another embodiment, region 40 can exist at all times in interface 10.

In the example of FIG. 1C, region 40 includes five buttons as part of a menu. These buttons include “by song,” “music video,” “artist,” “trivia game” and “other songs by artist.” If the user selects “by song” then the user will be provided the opportunity to purchase the song being played on the television show or movie. The user will be brought to an e-commerce page or site in order to make the purchase. The purchased song will then be available on the current computing device being used by the user and/or any of the other computing devices owned or operated by the user (as configurable by the user). If the user selects “music video,” then the user will be provided with the opportunity to view a music video on interface 10 (immediately or later), store the music video for later viewing, or send the music video to another person. If the user selects “artist,” the user will be provided with more information about the artist. If the user selects “trivia game,” then the user will be provided with a trivia game to play that is associated with or otherwise relevant to the song. If the user selects “other songs by artist,” then the user will be provided with the interface that displays all or some of the other songs by the same artist as the song currently being played. The user will be able to listen to, purchase, or tell a friend about any of the songs depicted.

Note that FIG. 1C is only on example of what can be provided in region 40. The system disclosed herein is fully configurable and programmable to offer many different types of interactions.

In one embodiment, region 40 is populated by invoking a set of code associated with event identifier 20 in response to the user interacting with alert 22. Each event is associated with event data that includes code (or a pointer to code) and content. That code and content is used to implement the interaction (e.g., the menu of region 40 and other functions performed in response to selecting any of the buttons of region 40).

FIGS. 1A-C show multiple event identifiers, each which indicate the temporal locations of the associated events within the content being displayed on interface 10. Each of these identifiers are associated with a different event, which in turn has its own set of code and content for programming the computing device associated with interface 10 to implement different sets of functions within region 40 (or elsewhere). In one embodiment, the event data for each event is different. That is, the code is not exactly the same for each event and the content for each event is not exactly the same. It is possible that multiple events will share some content and some code but the overall set of code and content for one event is likely to be different than the overall set of code and content for another event. Additionally, the various content provided will be of different mediums (e.g., audio, video, images, etc.).

In one embodiment, a user has the ability to jump from one event indicator to another. So for example, if a user missed an alert or even saw an alert but decided not to respond to it, later on in the playback experience, the user may wish to go back to a previous alert. The system will include a mechanism to jump between event indicators quickly.

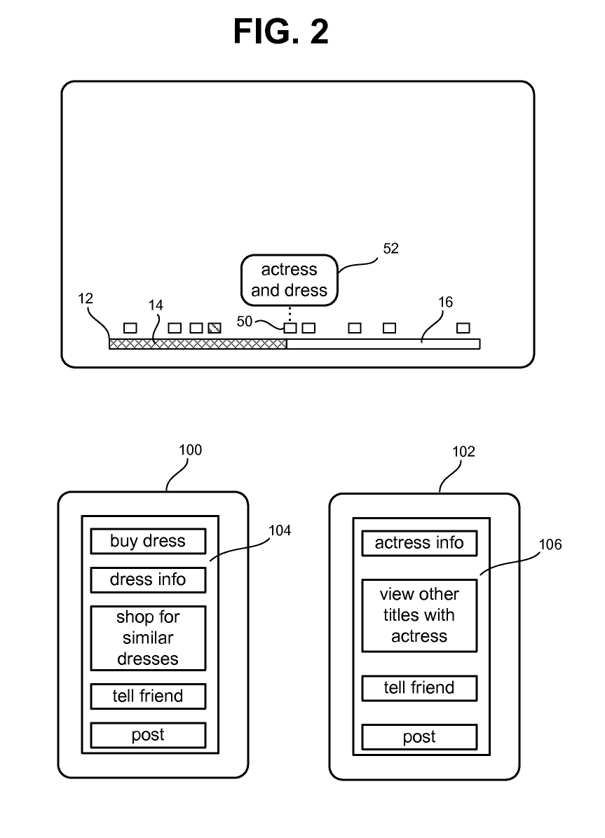

FIG. 2 provides another example where interface 10 (e.g., a high definition television) is used in conjunction with one or two companion devices. For example, FIG. 2 shows companion device 100 and companion device 102. In one embodiment, companion devices 100 and 102 are cellular telephones (e.g., Smartphones). In other embodiments, companion devices 100 and 102 can be notebook computers, tablets, or other wireless and/or mobile computing devices. In one embodiment, both companion devices 100 and 102 are being operated by the same user. In another embodiment, different users can be operating the companion devices such that a first user is operating companion device 100 and a second user is operating companion device 102. In many cases, the users operating the companion devices are also viewing interface 10. In one example, two people are sitting on a couch watching television (interface 10) while each also can view his/her own cellular telephone (100 and 102).

In the example of FIG. 2, event indicator 50 is associated with an event of an actress entering a scene wearing a particular dress. In this case, either of the two users watching the television show of movie can interact with the alert 52 using any of the means discussed herein. If the first user interacts with alert 52, then the first user's companion device 100 will be configured to show the various buttons of the menu for the user to interact with. For example, area 104 of companion device 100 shows five buttons for the user to buy the dress depicted in the movie (buy dress), get information about the dress (dress info), shop for similar dresses via the internet (shop for similar dresses), tell a friend about the dress (tell a friend) via social networking instant messaging, e-mail, etc., or post a comment about the dress (post). If the second user interacts with alert 52 as discussed above, then companion computing device 102 for the second user will show a set of buttons for a menu on region 106 of companion device 102. The second user can choose to get more information about the actress (actress info), view other movies or television shows that the actress was involved in (view other titles with actress), tell a friend about this particular actress and/or show (tell a friend) or post a comment (post). In one embodiment, both devices will display the same options for the same alert 52 (if the devices have the same capabilities).

In one embodiment, the first user and the second user will each have their own user profile known by the relevant computing device powering interface 10. Based on that profile, and the code and content associated with event indicator 50, the computing device will know which buttons and menu options to provide to the relative companion device for the particular user. The relevant code and content will be provided to the particular companion device in order to program the companion device to provide the interaction depicted in FIG. 2. Note that the code and content displayed to the user may also be based on other factors such as the capability of the devices (e.g., more multimedia-rich options might be shown to a laptop device as opposed to a mobile phone device), the time/date/location of the users/devices, etc., not just by the user profile. In some cases, there may not be a profile for the person viewing the content.

In other embodiments, regions 104 and 106 can also be displayed on interface 10, or other interfaces. The user can interact with interfaces 10, 104 and 106 by any of the means discussed herein. In another alternative, the user can interact with the alert 52 by performing an action on the user's companion device. In other embodiments, the timeline 12 can be depicted on any of the companion devices instead of or concurrently with being depicted on interface 10. In another alternative, the system will not issue alerts (e.g., alert 22 and alert 52). Instead, when the timeline reaches an event identifier, the user will automatically be provided with region 40, region 104 or region 106 which includes various menu items to select and/or other content in order to provide interactive experience during presentation of entertainment content.

The system providing the interaction can be fully programmable to provide any type of interaction using many different types of content. In one example, the system is deployed as a platform where more than one entity can provide a layer of content. In one example, a layer of content is defined as a set of event data for multiple events. The set of events in a layer can be of the same type of event or different types of events. For example, a layer can include a set of events that will provide shopping experiences, a set of events that provide information, a set of events that allow a user to play a game, etc. Alternatively, a layer can include a set of events of mixed types. Layers can be provided by the owner and provider of a TV show or movie (or other content), the user viewing the content, the broadcaster, or any other entity. The relevant system can combine one or more layers such that timeline 12 and its associated event identifiers will show identifiers for all layers combined (or a subset of such layers).

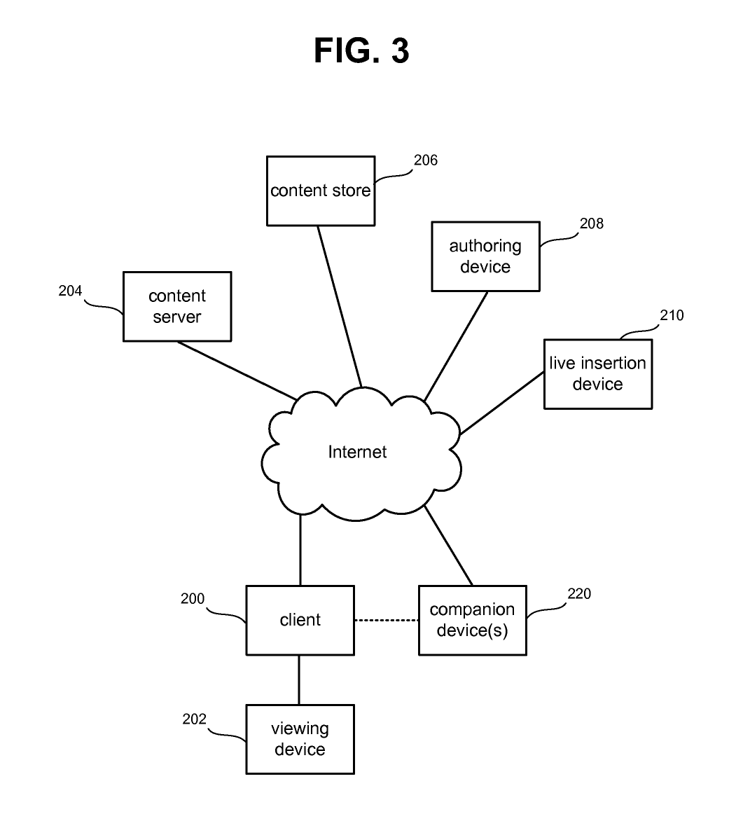

FIG. 3 is a block diagram depicting various components of one implementation of a system for providing the interaction described herein. FIG. 3 shows a client computing device 200, which can be a desktop computer, notebook computer, set top box, entertainment console, or other computing device that can communicate with the other components of FIG. 3 via the Internet using any means known in the art. In one embodiment, client computing device 200 is connected to a viewing device 202 (e.g., television, monitor, projector, etc.). In one alternative, client computing device 200 includes a built-in viewing device; therefore, it is not necessary to have an external viewing device.

FIG. 3 also shows content server 204, content store 206, authoring device 208 and live insertion device 210, all of which are in communication with each other and client computing device 200 via the Internet or other network. In one embodiment, content server 204 includes one or more servers (e.g., computing devices configured as servers) that can provide various types of content (e.g., television shows, movies, videos, songs, etc.). In some embodiments, the one or more content servers 204 store the content locally. In other embodiments, content server 204 stores its content at a content store 206, which could include one or more data storage devices for storing various forms of content. Content server 204 and/or content store 206 can also store various layers which can be provided by content server 204 and/or content store 206 to client 200 for allowing a user to interact with client 200. Authoring device 208 can include one or more computing devices that can be used to create one or more layers which are stored at content server 204, content store 206 or elsewhere. Although FIG. 3 shows one authoring device 208, in some embodiments, there can be multiple authoring devices 208. The authoring device(s) may interact directly with content server and/or content store and may not need to go through internet.

FIG. 3 also shows live insertion device 210, which can be one or more computing devices used to create a layer on the fly, in real time, during a live occurrence. For example, live insertion device 210 can be used to create event data in real time during a sporting event. Although FIG. 3 shows one live insertion device 210, the system can include multiple live insertion devices. In another embodiment, authoring device 208 can also include all the functionality of live insertion device 210.

FIG. 3 also shows a companion device 220, which is in communication with client 200 via the internet or directly (as depicted by the dotted line). For example, companion device 220 can communicate directly with client 200 via Wi-Fi, Bluetooth, infrared, or other communication means. Alternatively, companion device 220 can communicate directly with client 200 via the internet or via content server 204 (or another server or service). Although FIG. 3 shows one companion device 220, a system can include one or multiple companion devices (e.g., such as companion device 100 and companion device 102 of FIG. 2). Companion device 200 can also communicate with content server 204, content store 206, authoring device 208 and live insertion device 210 via the Internet or other network.

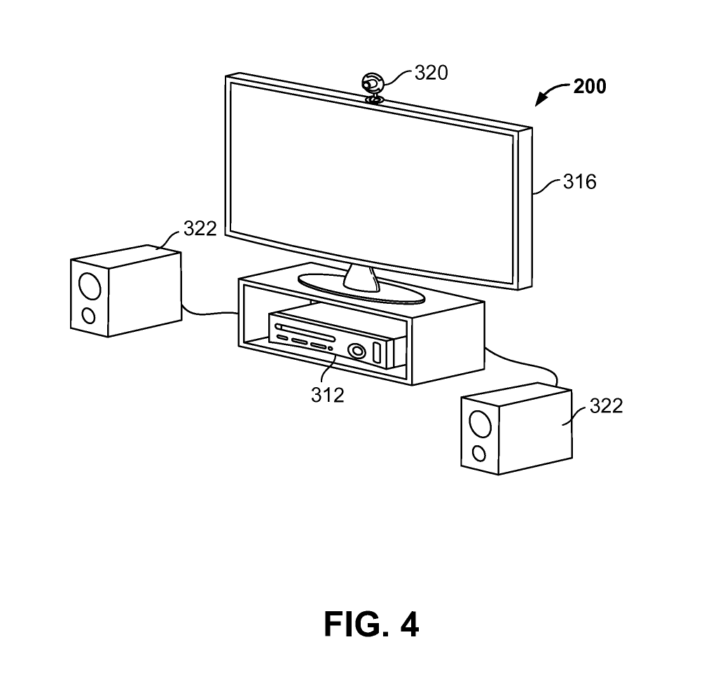

One example of client 200 is an entertainment console that can provide video game, television, video recording, computing and communication services. FIG. 4 provides an example embodiment of such an entertainment console that includes a computing system 312. The computing system 312 may be a computer, a gaming system or console, or the like. According to an example embodiment, computing system 312 may include hardware components and/or software components such that computing system 312 may be used to execute applications such as gaming applications, non-gaming applications, or the like. In one embodiment, computing system 312 may include a processor such as a standardized processor, a specialized processor, a microprocessor, or the like that may execute instructions stored on a processor readable storage device for performing the processes described herein. Client 200 may also include an optional capture device 320, which may be, for example, a camera that can visually monitor one or more users such that gestures and/or movements performed by the one or more users may be captured, analyzed, and tracked to perform one or more controls or actions within an application and/or animate an avatar or on-screen character.

According to one embodiment, computing system 312 may be connected to an audio/visual device 316 such as a television, a monitor, a high-definition television (HDTV), or the like that may provide television, movie, video, game or application visuals and/or audio to a user. For example, the computing system 312 may include a video adapter such as a graphics card and/or an audio adapter such as a sound card that may provide audiovisual signals associated with the game application, non-game application, or the like. The audio/visual device 316 may receive the audio/visual signals from the computing system 312 and may then output the television, movie, video, game or application visuals and/or audio to the user. According to one embodiment, audio/visual device 316 may be connected to the computing system 312 via, for example, an S-Video cable, a coaxial cable, an HDMI cable, a DVI cable, a VGA cable, component video cable, or the like.

Client 200 may be used to recognize, analyze, and/or track one or more humans. For example, a user may be tracked using the capture device 320 such that the gestures and/or movements of user may be captured to animate an avatar or on-screen character and/or may be interpreted as controls that may be used to affect the application being executed by computing system 312. Thus, according to one embodiment, a user may move his or her body (e.g., using gestures) to control the interaction with a program being displayed on audio/visual device 316.

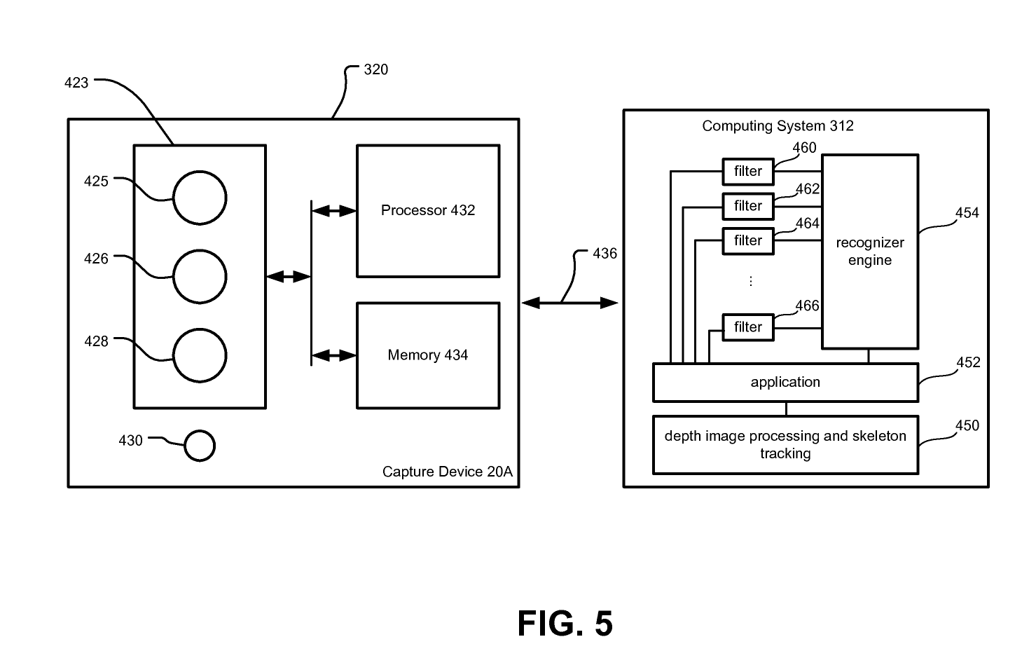

FIG. 5 illustrates an example embodiment of computing system 312 with capture device 320. According to an example embodiment, capture device 320 may be configured to capture video with depth information including a depth image that may include depth values via any suitable technique including, for example, time-of-flight, structured light, stereo image, or the like. According to one embodiment, the capture device 320 may organize the depth information into “Z levels,” or levels that may be perpendicular to a Z axis extending from the depth camera along its line of sight.

As shown in FIG. 5, capture device 320 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 320 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. In some embodiments, pulsed infrared light may be used such that the time between an outgoing light pulse and a corresponding incoming light pulse may be measured and used to determine a physical distance from the capture device 320 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 320 to a particular location on the targets or objects by analyzing the intensity of the reflected beam of light over time via various techniques including, for example, shuttered light pulse imaging.

In another example embodiment, capture device 320 may use a structured light to capture depth information. In such an analysis, patterned light (i.e., light displayed as a known pattern such as grid pattern, a stripe pattern, or different pattern) may be projected onto the scene via, for example, the IR light component 424. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR Light component 425 is displaced from the cameras 425 and 426 so triangulation can be used to determined distance from cameras 425 and 426. In some implementations, the capture device 20A will include a dedicated IR sensor to sense the IR light, or a sensor with an IR filter.

According to another embodiment, the capture device 320 may include two or more physically separated cameras that may view a scene from different angles to obtain visual stereo data that may be resolved to generate depth information. Other types of depth image sensors can also be used to create a depth image.

The capture device 320 may further include a microphone 430, which includes a transducer or sensor that may receive and convert sound into an electrical signal. Microphone 430 may be used to receive audio signals that may also be provided by computing system 312.

In an example embodiment, capture device 320 may further include a processor 432 that may be in communication with the image camera component 423. Processor 432 may include a standardized processor, a specialized processor, a microprocessor, or the like that may execute instructions including, for example, instructions for receiving a depth image, generating the appropriate data format (e.g., frame) and transmitting the data to computing system 312.

Capture device 320 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 5, in one embodiment, memory 434 may be a separate component in communication with the image capture component 423 and processor 432. According to another embodiment, the memory 434 may be integrated into processor 432 and/or the image capture component 422.

Capture device 320 is in communication with computing system 312 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, computing system 312 may provide a clock to capture device 320 that may be used to determine when to capture, for example, a scene via the communication link 436. Additionally, the capture device 320 provides the depth information and visual (e.g., RGB) images captured by, for example, the 3-D camera 426 and/or the RGB camera 428 to hub computing system 12 via the communication link 436. In one embodiment, the depth images and visual images are transmitted at 30 frames per second; however, other frame rates can be used. Computing system 312 may then create and use a model, depth information, and captured images to, for example, control an application such as a game or word processor and/or animate an avatar or on-screen character.

Computing system 312 includes depth image processing and skeletal tracking module 450, which uses the depth images to track one or more persons detectable by the depth camera function of capture device 320. Depth image processing and skeletal tracking module 450 provides the tracking information to application 453, which can be a video game, productivity application, communications application, interactive software (performing the processes described herein) or other software application etc. The audio data and visual image data is also provided to application 452 and depth image processing and skeletal tracking module 450. Application 452 provides the tracking information, audio data and visual image data to recognizer engine 454. In another embodiment, recognizer engine 454 receives the tracking information directly from depth image processing and skeletal tracking module 450 and receives the audio data and visual image data directly from capture device 320.

Recognizer engine 454 is associated with a collection of filters 460, 462, 464, . . . , 466 each comprising information concerning a gesture, action or condition that may be performed by any person or object detectable by capture device 320. For example, the data from capture device 320 may be processed by filters 460, 462, 464, . . . , 466 to identify when a user or group of users has performed one or more gestures or other actions. Those gestures may be associated with various controls, objects or conditions of application 452. Thus, computing system 312 may use the recognizer engine 454, with the filters, to interpret and track movement of objects (including people).

Capture device 320 provides RGB images (or visual images in other formats or color spaces) and depth images to computing system 312. The depth image may be a plurality of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device. Computing system 312 will use the RGB images and depth images to track a user's or object's movements. For example, the system will track a skeleton of a person using the depth images. There are many methods that can be used to track the skeleton of a person using depth images. One suitable example of tracking a skeleton using depth image is provided in U.S. patent application Ser. 12/603,437, “Pose Tracking Pipeline” filed on Oct. 21, 2009, Craig, et al. (hereinafter referred to as the '437 Application), incorporated herein by reference in its entirety. The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for tracking can also be used. Suitable tracking technologies are also disclosed in the following four U.S. Patent Applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

Recognizer engine 454 includes multiple filters 460, 462, 464, . . . , 466 to determine a gesture or action. A filter comprises information defining a gesture, action or condition along with parameters, or metadata, for that gesture, action or condition. For instance, a throw, which comprises motion of one of the hands from behind the rear of the body to past the front of the body, may be implemented as a gesture comprising information representing the movement of one of the hands of the user from behind the rear of the body to past the front of the body, as that movement would be captured by the depth camera. Parameters may then be set for that gesture. Where the gesture is a throw, a parameter may be a threshold velocity that the hand has to reach, a distance the hand travels (either absolute, or relative to the size of the user as a whole), and a confidence rating by the recognizer engine that the gesture occurred. These parameters for the gesture may vary between applications, between contexts of a single application, or within one context of one application over time. Another example of a supported gesture is pointing to an item on a user interface.

Filters may be modular or interchangeable. In one embodiment, a filter has a number of inputs (each of those inputs having a type) and a number of outputs (each of those outputs having a type). A first filter may be replaced with a second filter that has the same number and types of inputs and outputs as the first filter without altering any other aspect of the recognizer engine architecture. For instance, there may be a first filter for driving that takes as input skeletal data and outputs a confidence that the gesture associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

A filter need not have a parameter. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Inputs to a filter may comprise things such as joint data about a user's joint position, angles formed by the bones that meet at the joint, RGB color data from the scene, and the rate of change of an aspect of the user. Outputs from a filter may comprise things such as the confidence that a given gesture is being made, the speed at which a gesture motion is made, and a time at which a gesture motion is made.

Recognizer engine 454 may have a base recognizer engine that provides functionality to the filters. In one embodiment, the functionality that recognizer engine 454 implements includes an input-over-time archive that tracks recognized gestures and other input, a Hidden Markov Model implementation (where the modeled system is assumed to be a Markov process—one where a present state encapsulates any past state information used to determine a future state, so no other past state information must be maintained for this purpose—with unknown parameters, and hidden parameters are determined from the observable data), as well as other functionality used to solve particular instances of gesture recognition.

Filters 460, 462, 464, . . . , 466 are loaded and implemented on top of the recognizer engine 454 and can utilize services provided by recognizer engine 454 to all filters 460, 462, 464, . . . , 466. In one embodiment, recognizer engine 454 receives data to determine whether it meets the requirements of any filter 460, 462, 464, . . . , 466. Since these provided services, such as parsing the input, are provided once by recognizer engine 454 rather than by each filter 460, 462, 464, . . . , 466, such a service need only be processed once in a period of time as opposed to once per filter for that period, so the processing used to determine gestures is reduced.

Application 452 may use the filters 460, 462, 464, . . . , 466 provided with the recognizer engine 454, or it may provide its own filter, which plugs in to recognizer engine 454. In one embodiment, all filters have a common interface to enable this plug-in characteristic. Further, all filters may utilize parameters, so a single gesture tool below may be used to debug and tune the entire filter system.

More information about recognizer engine 454 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23,2009; and U.S. patent application Ser. No. 12/474,655, “Gesture Tool” filed on May 29, 2009. both of which are incorporated herein by reference in their entirety.

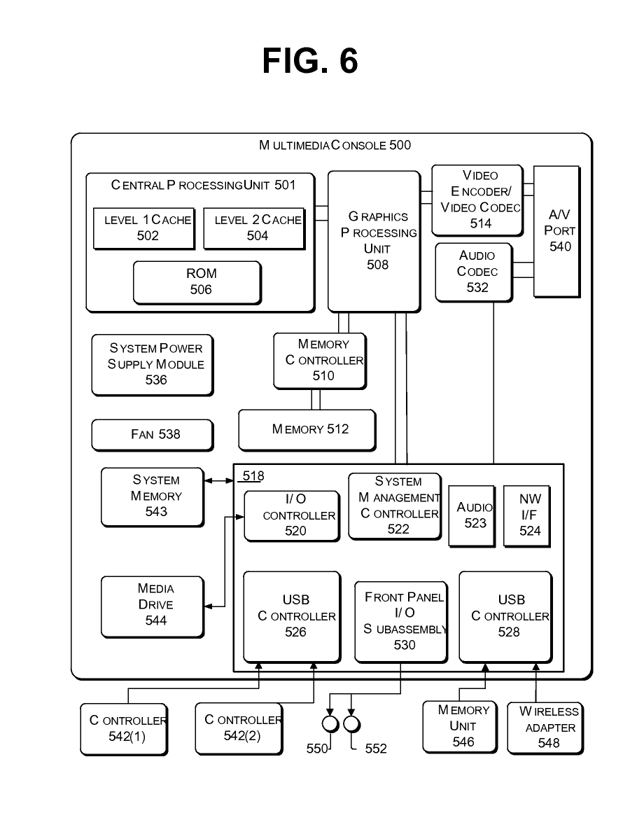

The system described above with respect to FIGS. 5 and 6 allows a user to interact or select an alert (e.g., bubble 22 of FIGS. 1B and 1C) by using a gesture to point to the bubble with the user's hand without touching a computer mouse or other computer pointing hardware. The user can also interact with region 40 of FIG. 1(or other user interfaces) using one or more gestures.

FIG. 6 illustrates an example embodiment of a computing system that may be used to implement computing system 312. As shown in FIG. 6, the multimedia console 500 has a central processing unit (CPU) 501 having a level 1 cache 502, a level 2 cache 504, and a flash ROM (Read Only Memory) 506 that is non-volatile storage. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network (or communication) interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548 (another example of a communication interface), and an external memory device 546 (e.g., flash memory, external CD/DVD ROM drive, removable media, etc. any of which may be non-volatile storage). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. (any of which may be non-volatile storage). The media drive 144 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 100. A system power supply module 536 provides power to the components of the multimedia console 100. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 320 may define additional input devices for the console 500 via USB controller 526 or other interface. In other embodiments, computing system 312 can be implemented using other hardware architectures. No one hardware architecture is required.

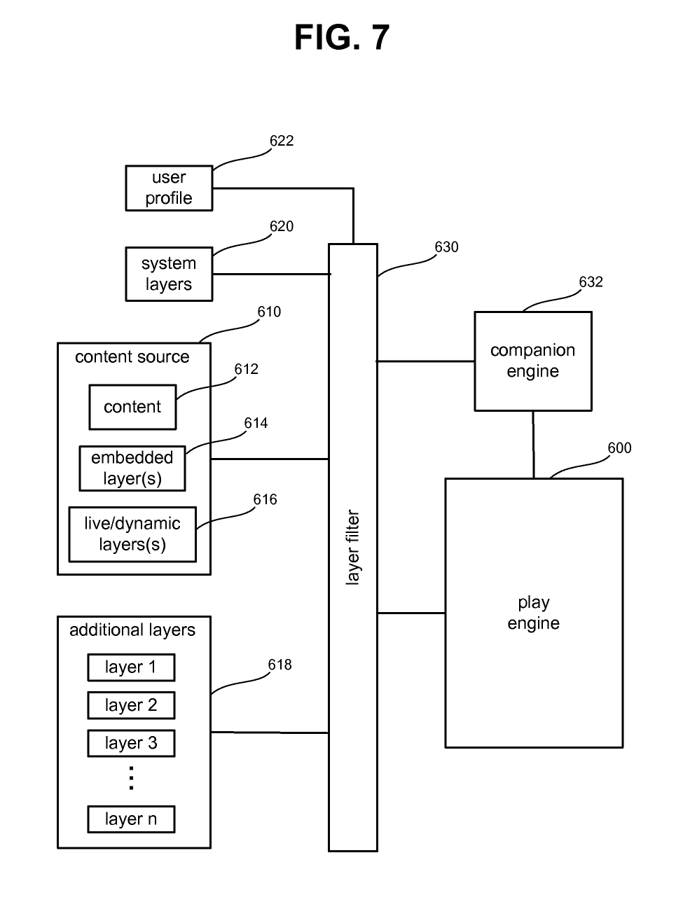

While FIGS. 3-6 describe various hardware components used to implement the interaction with entertainment content described herein, FIG. 7 provides a block diagram of some of the software components for one embodiment of the system for providing interaction. Play engine 600 is a software application running on client 200 that presents the interactive content described herein. In one embodiment, play engine 600 may also play the appropriate movie, television show, etc. Play engine 600 will use various sets of layers to provide interaction according to the processes described below.

The layers can come from different sources. One source of layers includes the source 610 of the underlying content. For example, if the underlying content being provided to the user is a movie, the source of the underlying content is the creator, studio or distributor of the movie. That content source 610 would provide the content itself 612 (e.g., the movie, television show, . . . ) and a set of one or more layers 614 embedded in the content. If content is being streamed to play engine 600, the embedded layers 614 can be in the same stream as content 12. If content 612 was on a DVD, the embedded layers 614 can be stored on the same DVD and/or in the same MPEG data stream as the movie or television show. The layers can also be streamed, transmitted, stored or otherwise provided separately from the content (e.g., move, television show, etc.). The content source 610 can also provide live or dynamic layers 16. A live layer would be a layer that is created during a live occurrence (e.g., sporting event). A dynamic layer is a layer that is created by the content source, by the play engine or other entity dynamically on the fly during presentation of content. For example, during a video game, if a certain event happens in the video game, event data can be generated for that event so the user can interact with the system in response to that event. That event data can be generated dynamically by play engine 600 based on what is happening in the video game. For example, if an avatar in a video game succeeds at a quest, interactive content can be provided that allows a user to obtain more information about the quest and/or the avatar.

Another source of layers can be third parties. For example, FIG. 7 shows additional layers 618 including layer 1, layer 2, layer 3, . . . which can be from one or more third parties who can provide the layers to play engine 600 for free or at a fee (pay in advance, pay on the fly, subscription, etc.).

Additionally, there can be system layers associated with play engine 600. For example, play engine 600 can include certain system layers embedded in player engine 600 or the operating system for the computing device running play engine 600. One example relates to instant messaging. An instant messaging application that may be part of a computing device or operating system, and can be pre-configured with one or more layers so that as a user receives an instant message an event is generated and interaction can be provided in response to the instant message (and/or the content of the instant message).

FIG. 7 also shows user profile data 622, which can be for one or multiple users. Each user would include its own user profile. A user profile would include personal and demographic information about a user. For example, a user profile can include (but is not limited to) name, age, birthday, address, likes, dislikes, occupation, employer, family members, friends, purchase history, sports participation history, preferences, etc.

The different types of layers 610, 616, 618 and 620 are provided to layer filter 630. Additionally, the user profile information 622 is provided to layer filter 630. In one embodiment, layer filter 630 filters the layers received based on the user profile data. For example, if a particular movie being viewed is associated with 20 layers, layer filter 630 can filter those 20 layers so that only 12 layers (or another number) are provided to play engine 600 based on the user profile data associated with the user interacting with play engine 600. In one embodiment, layer filter 630 and play engine 600 are implemented on client 200. In another embodiment, layer filter 630 is implemented in content server 204 or at another entity.

The content 612 (e.g., movie, television show, video, song, etc) and the various layers can be provided to play engine 600 in the same stream (or other package). Alternatively, one or more of the layers can be provided to play engine 600 in a different set of one or more streams than the stream providing content 612 to play engine 600. The various layers can be provided to play engine 600 at the same time as content 612, prior to content 612 or after content 612 is provided to play engine 600. For example, one or more layers can be pre-stored locally to play engine 600. In other embodiments, one or more layers can be stored on companion engine 632, which is also in communication with play engine 600 and layer filter 630, so that companion engine 632 can provide the layers to play engine 600 and receive layers from filter 630.

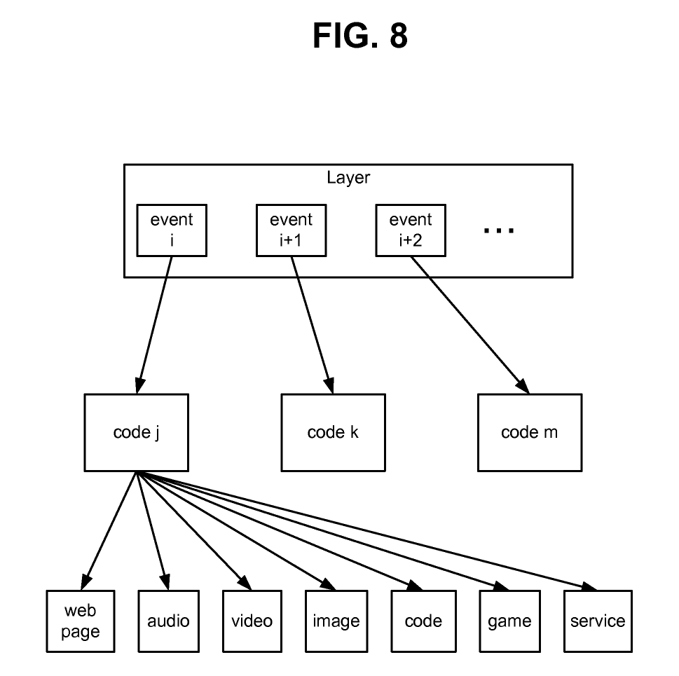

FIG. 8 is a block diagram depicting an example structure of a layer. As can be seen, the layer includes event data for a number of events (event i, event i+1, event i+2, . . . In one embodiment, each event is associated with its own set of code. For example, event i associated with code j, event i+1 is associated with code k, and event i+2 is associated with code m. Each set of code will also include one or more content items (e.g., video, images, audio, etc.). For example, code j is depicted having content items including a web page, audio content, video content, image content, additional code for performing further interaction, games (e.g., video games), or other service. In one example implementation, each event identifier (see FIGS. 1A-1C) will include one or more pointers or other references to the associated code, and the associated code will include one or more pointers or other references to the content items. Each set of code (e.g., code j, code k, code m) includes one or more software modules that would create the user interface of region 40 of FIG. 1C, region 104 of FIG. 2 or region 106 of FIG. 2, and one or more modules that are performed to carry out the functions in response to a user selecting any of the interface items in regions 40, 104 or 106. The sets of code can be in any computer language known in the art, including high level programming languages and machine level programming languages. In one example, the sets of code are written using Java code.

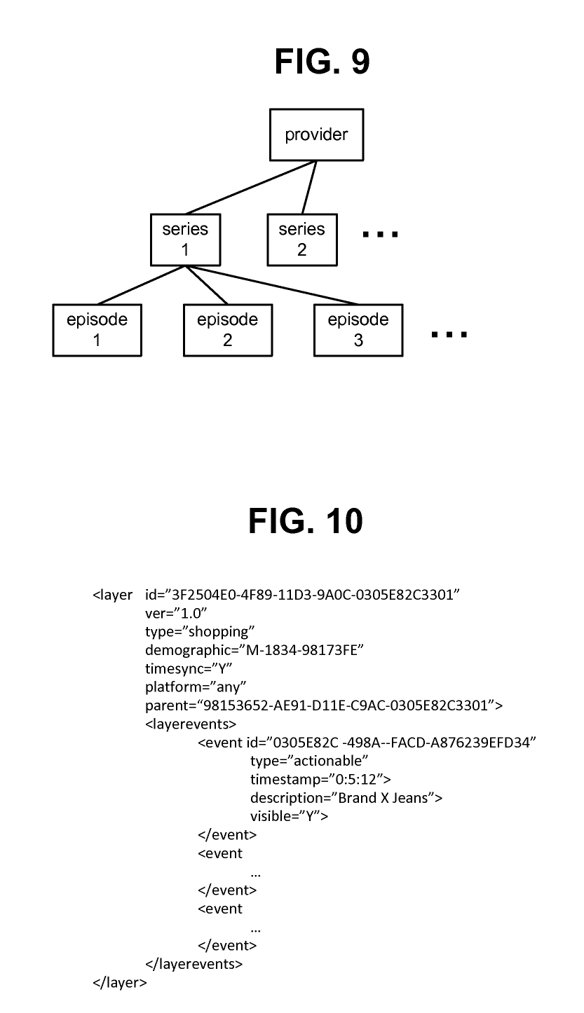

As explained above, it is contemplated that a particular program (audio, video, TV, movie, etc.) can include multiple layers. In one implementation, the layers can be hierarchal. FIG. 9 provides an example of a hierarchal set of layers. Each layer has a reference to its parent layer so that the hierarchy can be understood by play engine 600 or another entity. For example, play engine 600 would identify all of the layers in a particular hierarchy and then determine which portion of that hierarchy pertains to the particular program about to be viewed.

In the example of FIG. 9, at the top of the hierarchy is a “provider” layer. This layer may be created by a producer, studio, production company, broadcaster or television station. The layer is meant to be played along with every show from that provider. It is anticipated that that provider will distribute many different television series (e.g., series 1, series 2 . . . ). The “provider” layer will be used to interact with every show of every series for that provider. The hierarchy also shows a bunch of “series” layers (e.g., series 1, series 2, . . . ). Each “series” layer is a set of events to be used for interaction for every show in that series. Below the “series,” each episode of each series will have its own set of one or more layers. FIG. 9 shows the episode layers (episode 1 layer, episode 2 layer, episode 3 layer, . . . ). In one example, episode 2 (using the hierarchy of FIG. 9), will include three layers. The first layer is a layer specifically and only for episode 2. The second layer is a layer for all episodes in series 1. The third layer to be used is the layer for every episode of every series distributed by the particular provider.

FIG. 10 provides sample code for defining a layer. In one embodiment, the code for defining a layer is provided in XML format; however, other formats can be used. It is this XML code that is streamed to or otherwise stored on or near play engine 600. The code of FIG. 10 provides enough information for play engine 600 to create the various event identifiers depicted in FIGS. 1A-C and 2. Looking at the code of FIG. 10, the first line provides a layer ID. This is a global unique identification for the layer. As it is anticipated that layers may evolve over time, the second line of code provides the version number for the layer technology. The third line indicates the type of layer. As discussed above, some layers may be a particular type of layer (e.g., shopping, information, games, etc.). Another layer type can be a mixed layer (e.g., shopping and information and games, etc.). The fourth line indicates a demographic value. This demographic value can be compared against the contents of a user profile for a user interacting with the particular program to determine whether this layer should be filtered out or into the interaction. In one embodiment, all the possible permutations of user profile, or a set of subsets of permutations, are assigned identification or code numbers (such as the one depicted in FIG. 10). Some layers are time synchronized, while others are not. The code of FIG. 10 indicates whether this layer is time synchronized (time sync=“Y”). The layer could also indicate what software and/or hardware platforms the layer is capable of being operated on. The layer will also include a “parent” field that indicates the global or unique ID for the parent layer in a hierarchal structure of layers. The layer creator could also use these fields to specify their preference on where the layer appears—so if there is a primary device and a companion device in the eco-system, the creator can specify that they wish for that particular event to appear only on the primary screen or only on the secondary screens (e.g., the creator might want things like trivia games to appear on a more private screen than on the common screen).

The data of FIG. 10 discussed above is referred to as header information that applies to all events for a layer. Following the header information, a series of events will be defined. Each event corresponds to an event identifier (as depicted in FIGS. 1 and 2). The code of FIG. 10 only shows code for one event, having an event ID equal to “0305E82C-498A-FACD-A876239EFD34.” The code of FIG. 10 also indicates whether the event is actionable or not. If an event is actionable, an alert will be provided, and if that alert is interacted with then the “event ID” will be used to access code associated with that event ID. In one embodiment, the alert associated with the event will be a text bubble (or other shape) with the text defined by the “description field.” Events can be visible or invisible, as indicated by the “visible” field.

In one embodiment, a table will store a mapping of event ID to code. In another embodiment, the event ID will be the name of t he file storing the code. In another embodiment, the file storing the code will also store the event ID. Other means for correlating event ID to code can also be used.

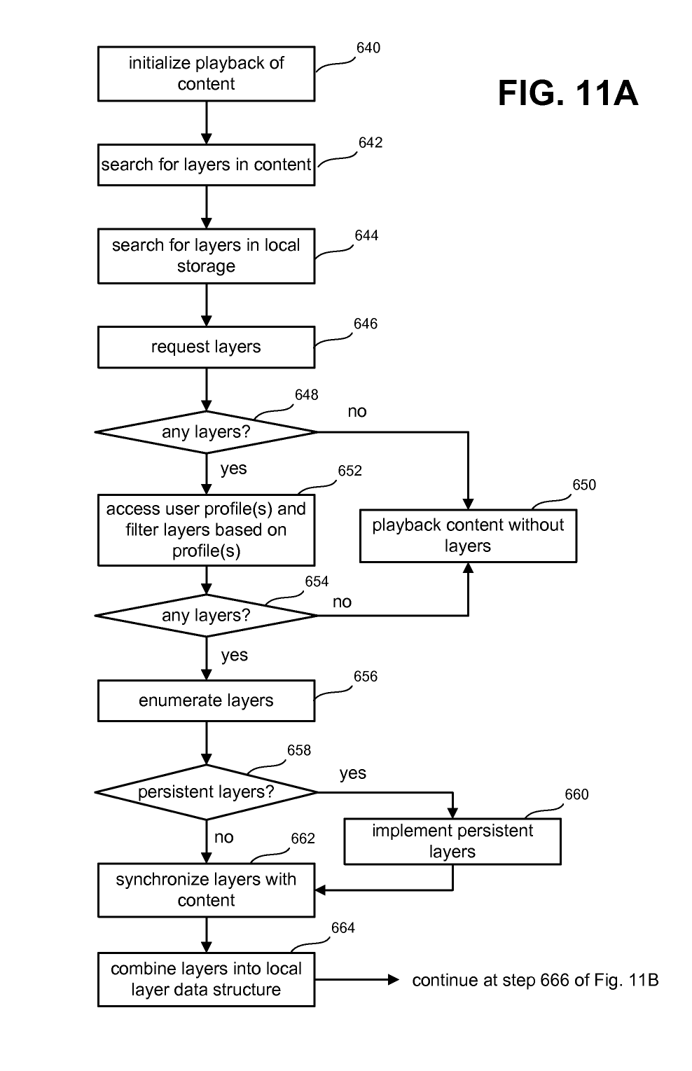

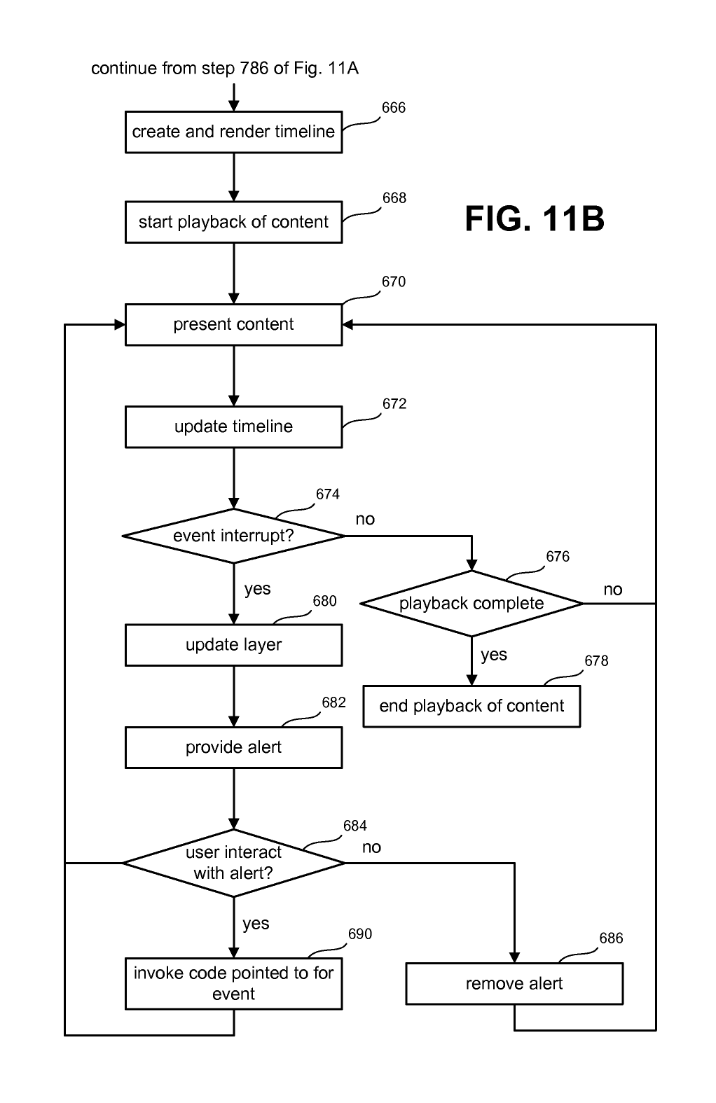

FIGS. 11A and 11B provide a flowchart describing one embodiment of a process for providing the interaction with content described herein. The steps of FIGS. 11A and 11B are performed by or at the direction of play engine 600. In some embodiments, additional components can also be used to perform one or more steps of FIGS. 11A and 11B. In step 640 of FIG. 11A, the system will initialize playback of content. For example, a user may order a television show or movie on demand, tune into a show or movie on a channel, request a video or audio from a web site or content provider, etc. The appropriate content requested by the user will be accessed. Any necessary licenses will be obtained. Any necessary decryption will be performed such that the content requested will be ready for playback. In one embodiment of step 640, the client computing device 200 will request content to be streamed.

In step 642, the system will search for layers inside the content. For example, if the content is being streamed, the system will determine whether any layers are in the same stream. If the content is on a DVD, on a local hard disk, or other data structure, the system will look to see if there are any layers embedded in the content. In step 644, the system will look for any layers stored in a local storage, separate from the content. For example, the system will look at local hard disk drives, databases, servers, etc. In step 646, the system will request layers from one or more content servers 204, authoring devices 208, live insertion devices 210, content stores 206 or other entities. In steps 642-646, the system is using the unique ID for the content (e.g., TV program, movie, video, song, etc.) in order to identify layers associated with that content. There are multiple methods with which the layers can be found, given a content ID (e.g., lookup tables, etc.). If there are no layers found for that particular content (step 648), then the content initialized in step 640 is played back without any layers in step 650.

If the system did find layers relevant to that content about to be displayed to the user, then in step 652 the system will access the user profile(s) for one or more users interacting with client device 200. The system can identify the users who are interacting with the client device 200 by determining what users have logged in (e.g., using user name and password or other authentication means), by using the tracking system described above to automatically identify users based on visible features or tracking, based on the automatic detection of the presence of companion devices known to be associated with certain users, or other automatic or manual means). Based on the user profile(s) accessed in step 652, all the layers gathered in step 642-646 are filtered to identify those layers that satisfy the user profile data. For example, if the user profile indicates that the user hates shopping, then any layer that is identified as a shopping layer will be filtered out of the set gathered. If the user is a child, any layer with adult content will be filtered out. If after the filtering, there are no layers remaining (step 654), then the content initialized in step 640 is played back in step 650 without any layers (e.g. no interaction). If no user profiles are found, default data will be used. Note that filtering can also be performed based on any one or combination of device capabilities, time of day, season, date, physical location, IP address, and default language settings.

If the results of the filtering does include layers (step 654), then play engine 600 will enumerate the layers in step 656. That is, play engine 600 will read in the XML code (or other description) for all the layers. If any of the layers are persistent layers (step 658), then those layers will be implemented immediately in step 660. A persistent layer is one that is not time synchronized. Thus, the code associated with the layer is performed immediately without waiting for any events to occur. For those layers that are not persistent (step 658), the layers are synchronized with the content in step 662. As discussed above, the layers include a timestamp. In one embodiment, the timestamp is relative to the beginning of the movie. Therefore, to synchronize the events of a layer to a movie (or other content), the system must identify a start time for the movie and make all other timestamps relative to that start time. In the case where the content is non-linear (e.g., a game), the layer events may be synchronized against event triggers as opposed to timestamps. In step 664, all of the layers are combined into a data structure (“the layer data structure”). The layer data structure can be implemented in any form known to those of ordinary skill in the art. No particular structure or schema for the data structure is required. The purpose of the layer data structure is to allow the play engine 600 to accurately add event identifiers onto the timeline depicted above (or other user interface).

In step 666, play engine 600 will create and render the timeline (e.g., the timeline depicted in FIGS. 1A-C). As part of step 666, an event identifier will be added to the timeline for every event of each the layers added to the data structure in step 664. In some embodiments, some of the events will not include event identifiers. In other embodiments, there will be no timeline and/or no event identifiers. In step 668, playback of the content initially requested by the user starts. In step 670 a portion of content is presented to the user. For example, a number of frames of a video are provided to the user. After that portion is provided in step 670, the timeline is updated in step 672. For example, shaded portion 14 of timeline 12 will be enlarged (see FIG. 1A). In step 674, the system will determine whether there is an event identifier associated with the current position of the timeline. That is, the system will automatically determine whether there is an event having a timestamp corresponding to the current elapsed time in the content being provided to the user. In one example implementation interrupts are generated for each event based on the timestamp in the event data associated with the layer. Thus, play engine 600 can automatically determine that an event has occurred.

If no event has occurred, then in step 676 it is determined whether the playback of the content is complete. If playback is complete, then in step 678, playback is ended. If playback is not complete, then the process loops back to step 670 and presents the next portion of the content.

If playback engine 600 did automatically determine that an event occurred (in step 674), then in step 680, the playback engine will attempt to update the layer. It is possible that a layer has been updated since it was downloaded to play engine 600. Thus play engine 600 will attempt to download a newer version, if it exists. In step 682, the system will provide an alert for the event that just occurred. For example, a text bubble will be provided on a television screen. In step 684, it is determined whether the user has interacted with the alert. For example, the user can use a mouse to click on the text box, use a gesture to point to the text box, speak a predefined word, or use other means to indicate a selection of the alert. If the user did not interact with the alert (in step 684), then the alert is removed after a predetermined amount of time in step 686 and the process loops back to step 670 to present another portion of the content.

If client 200 determined that the user did interact with the alert (step 684), then the client will use the event ID to obtain the code associated with that event ID and invoke that code in order to program the client to implement the interactive content (see region 40 of FIG. 1C, region 104 of FIG. 2 and/or region 106 of FIG. 2). After invoking the code in step 690, the process will loop back to step 670 to present the next portion of content. In one embodiment, the content originally requested by the user will continue to be played while the user has the ability to interact with the code as explained above. In another embodiment, the content can be paused while the user interacts with the code. In another alternative, the code is used to program a companion device in addition to or instead of the main client computing device 200. In either case, the computing device that will provide the interaction is programmed using the code and any audio/visual content item associated with that code in response to receiving the user interaction with the alert. The computing device that will provide the interaction or any other computing device in the eco-system may be affected. For example, the user may be using a companion device for a trivia game but the main screen shows a clock on it to show other people in the audience how much time the user has left before he must respond with an answer. In this case, the main screen is not the computing device that will provide the interaction (the user accepted the trivia game and will be playing via their mobile phone companion device) but the main screen is affected by the user's interaction. Basically, any screen in the eco-system may be affected.

It is contemplated, that a layer will have multiple events. Each event will have different code and a different set of audio/visual content items associated with those events. In one example, the system may automatically determine that a first event has occurred, provide a first alert for that first event and receive a user interaction for that first alert. Client device 200 (or one or more companion devices) will be programmed using the code and the audio/visual content items associated with the first event in response to receiving the user interaction with the first alert. Subsequently, the system will automatically determine that a second event has occurred and provide a second alert for that second event. The system will program the client device 200 (or companion device) using the code and audio/visual content associated with the second in response to receiving the user interaction with the second alert. In many (but not all) instances, the software and audio/visual content associated with the second event is different (in one or more ways) than the software instructions and audio/visual content items associated with the first event.

In one embodiment, the system will display multiple event indicators from different layers superimposed at the same temporal location on the timeline. The user will get an alert indicating that multiple events are available and they would be able to toggle between the events (i.e., via area 40 of FIG. 1C or areas 104 and 106 of the companion devices). In this case, the system is controlling the user interface in those areas and not necessarily the code associated with the events triggered.

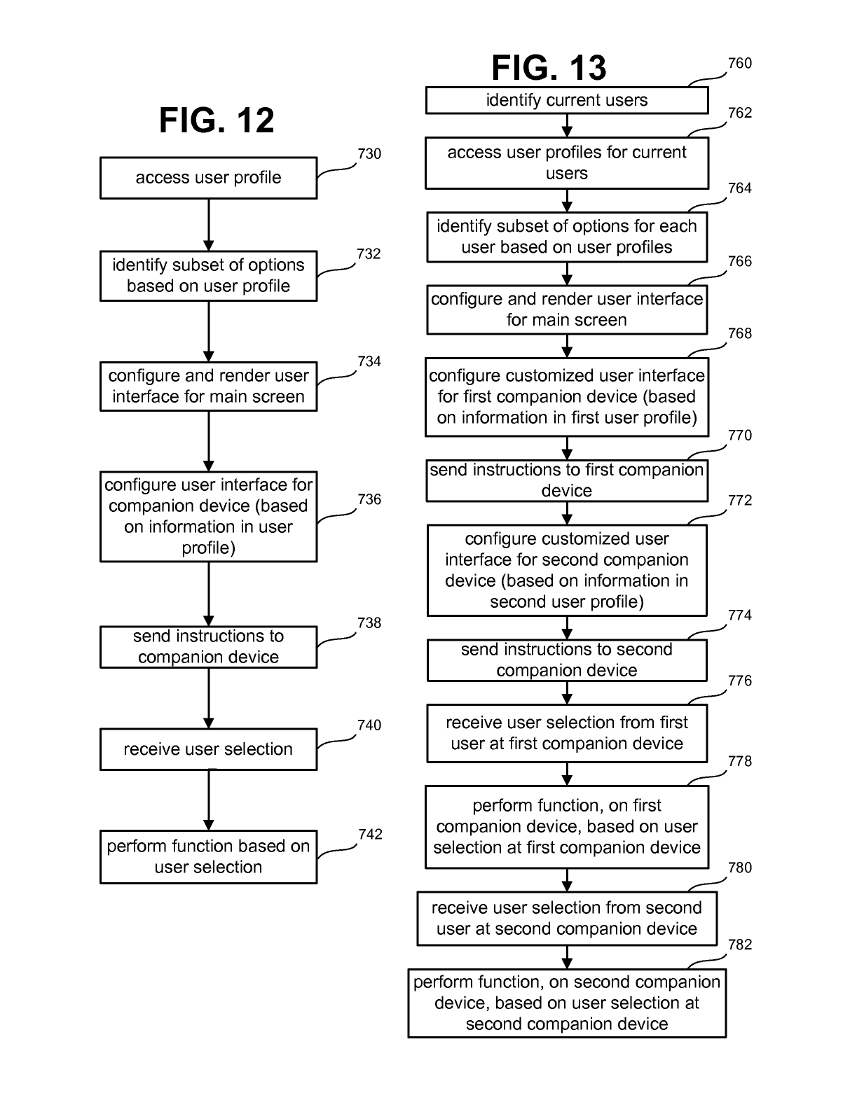

FIG. 12 is a flowchart describing one embodiment of a process for invoking code pointed to for an event, with respect to an embodiment that includes a companion device. The process of FIG. 12 provides more details of one embodiment of step 690 of FIG. 11B. In step 730 of FIG. 12, the system will access the user profile for the user currently interacting with the system. In step 732, the system will identify a subset of options based on the user profile. For example, the code associated with an event may include multiple options for implementing an interactive user interface (e.g., region 40 of FIG. 1C). The system can choose an option based on the user profile. For example, looking at FIG. 2, if the user indicates a preference for shopping for women's clothes, a user interface may be provided for shopping for a dress associated with the dress in the movie. If the user profile expresses a preference for actors and actresses, information about the actress displayed may be provided instead of the stress. In step 734, the system will configure and render the appropriate user interface based on the code and the user profile. This user interface will be for the main screen associated with interface 10 (FIG. 1 and FIG. 2) of client device 200.

In step 736 of FIG. 12, the system will configure a user interface for the companion device based on the information in the user profile and the code associated with the event. For example, the code may have different options for the main screen and different options for the companion device and will use the user profile to choose one of the options for the main screen and one of the options for the companion device. In one example, a user interface which may need to be more discrete may be displayed on the companion device. In step 738, client device 200 will send instructions (e.g., software) to companion device 220 in order to program the companion device to implement the user interface and provide the interaction described herein. That is, a set of buttons may be displayed and each button is associated with a function which is performed (by or via the companion devoce) in response to selection the button. The instructions can be sent to the companion device indirectly via the internet (e.g., using a server or service) or directly via Wi-Fi, Bluetooth, infrared, wired transmission, etc.

In step 740, the system receives a user selection on the main screen, the companion device or both. Whichever device or devices receives the user interaction will perform the requested function in step 742 using the code (e.g., software instructions) for the event. Note that in some embodiments there will be no companion device, while in other embodiments there can be multiple companion devices. In this example process of FIG. 12, the companion device, which can be a wireless computing device that is separate from the client computing device 200, is programmed based on the code and audio/visual content items associated with the event that was automatically detected in response to receiving the user interaction with the alert discussed above.

FIG. 13 is a flowchart describing one embodiment of a process for invoking one or more sets of code pointed to by an event when multiple users are interacting with companion devices or multiple users are interacting with the same client device 200. In step 760 of FIG. 13, the system will automatically identify a set of users currently and concurrently interacting with the system using any of the means discussed above. In one embodiment, for example, the depth camera discussed above can be used to automatically detect two or more users who are in a room watching or listening to a program. In step 762, the user profiles for both users will be accessed. In step 764, a subset of the possible options identified in the code for the event are determined (e.g., as a result of the filter) based on the user profiles. In one example, each user will be assigned a different option. In another example, both users can be assigned the same option for interacting with the content.

In step 766, the system will configure or render the user interface on the main screen (client device 200). For example, there may be interaction that both users can do together at the same time. In step 768 the system will configure a user interface for the first companion device based on the information in the first user's profile. In step 770, instructions for the first companion device are sent from client device 200 to the first companion device. In step 772, the system will configure a customized user interface for the second companion device based on the information in the second user's profile. In step 774, instructions are sent from client device 200 to the second companion device to implement the customized user interface for the second companion device. The instructions sent to the companion device includes the code and audio/visual items discussed above. In response to the code and audio/visual items, the two companion devices will implement the various user interfaces, as exemplified in FIG. 2.

In step 776, the user of the first companion device will make a selection of one of the items depicted. In step 778, a function is performed on the first companion device in response to the user selection on the first companion device. In step 780, the user of the second companion device will make a selection of one of the items displayed on the second companion device. In response to that selection, a function will be performed based on the user selection at the second companion device.

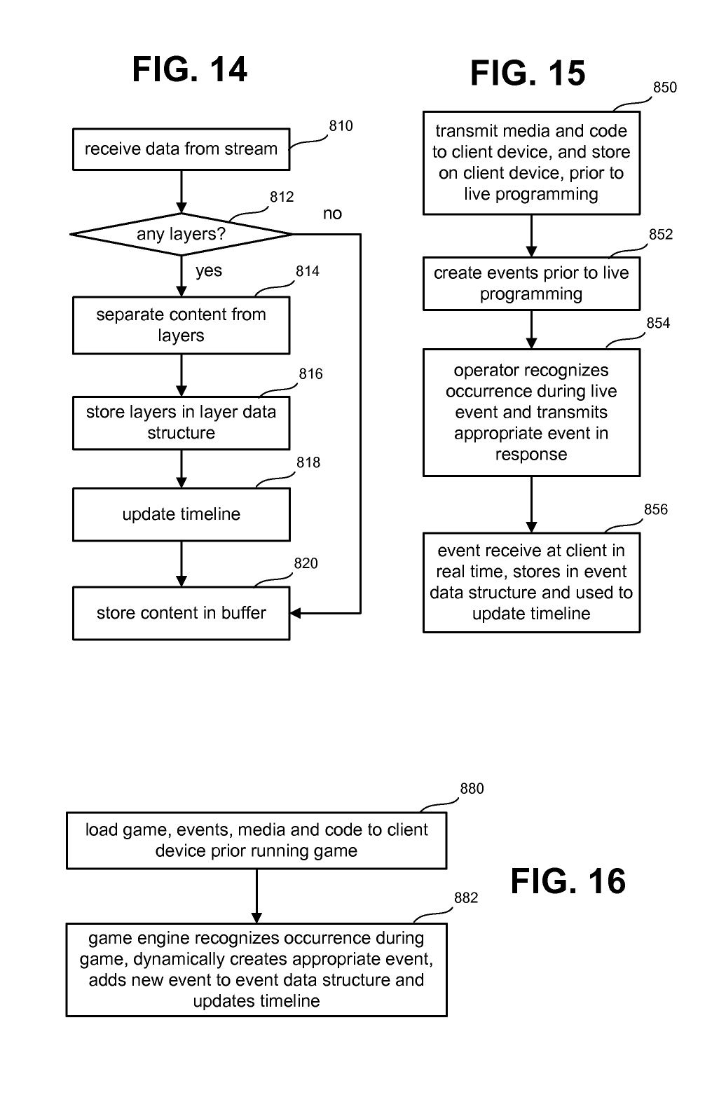

FIG. 14 provides a flowchart describing one embodiment of a process for receiving a stream of data. The process of FIG. 14 can be performed as part of steps 640, 642 and/or 646. In step 810 of FIG. 14, a data stream is received. In step 812, it is determined whether there are any layers in the data stream. If there are no layers in the data stream, then the content of the data stream is stored in a buffer at step 820 for eventual playback. If there are layers in the data stream (step 812), then in step 814 the layers are separated from the content. In step 816, the layers are stored in the layer data structure discussed above. If the content is already being presented (e.g. the stream is received while presenting the content), then the timeline currently being depicted is updated in step 818 to reflect the new one or more layers received. The content received is then stored in the buffer in step 820 for eventual playback.

FIG. 15 is a flowchart describing one embodiment of a process for receiving layers during live programming One challenge of live programming is that the timing of events (e.g., a first event and/or a second event) are not known before the live occurrence happens. Thus, the system may receive event information on the fly. In some implementations, the code and audio/video and content items for an event are pre-stored prior to a live occurrence, while in other instances that information can be generated and/or provided on the fly. When it is pre-stored, the provider of the layer need only provide the data depicted in FIG. 10, which takes up less bandwidth and may be transmitted quicker to the client 200.

In step 850 of FIG. 15, media and code are transmitted to the client device and stored on the client device prior to live programming. In step 852, events can be created prior to live programming. For example, for a football game, a television network can create event data (e.g., the code of FIG. 10) for various plays during the game and store the event data on the computer for the broadcaster. In step 854, an operator will recognize the event happening during a live program and transmit the appropriate event in response. For example, the particular play during a football viewed by the operator will have an event associated with it, and that event will be provided to client 200 in response to the operator recognizing the play in the football game. In step 856, the event is received at the client device 200 in real time, stored in the event data structure discussed above and used to update the timeline (as discussed above). In one embodiment, the content may appear slightly delayed (say, a few seconds) to the user since some amount of processing needs to occur before content is seen. The time delay should not be significant. The process of FIG. 15 can be performed any time during the performance of the process of FIGS. 11A-B in order to provide for real time generation of events.

FIG. 16 provides a flowchart describing one embodiment of a process for dynamically creating events during a video game (or other activity). In step 880, the system will load game logic, event data, media (audio/visual content items) and code for the event data to the client device 200 prior to running the game. In step 882, the game engine will perform the game. As part of step 882, the game engine will recognize an occurrence during the game and dynamically create an appropriate event to add to the layer data structure and update the timeline appropriately. In one embodiment, a new event indicator can be added to the current time in the timeline so that the event happens immediately. The event is dynamic because the game engine determines data about what just happened and configures the event data based on what just happened. For example if an avatar reached a plateau in some game, information about the plateau can be added to the event data. One of the options for interacting can be to find more information about the particular plateau or the particular game, or identify how many other people have reached that plateau, etc.

In another example, two avatars may be fighting in a video game. If one of the avatars is defeated, an event may be dynamically generated to provide information about the avatar who won the battle, why the avatar won the battle, other avatars who have lost to the same avatar who won the battle, etc. Alternatively, an option may be for the losing player to buy content to teach the losing player to be a better video player. There are many different options for providing dynamically generated events.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for providing interaction with a computing system, comprising:
accessing and displaying a program using the computing system;
identifying event data associated with the program, the event data includes data for a plurality of events, the data for the events includes references to software instructions and audio/visual content items;
automatically determining that a first event has occurred;
providing a first alert for the first event;
receiving a user interaction with the first alert;
programming the computing system using the software instructions and audio/visual content items associated with the first event in response to receiving the user interaction with the first alert;
automatically determining that a second event has occurred;
providing a second alert for the second event;
receiving a user interaction with the second alert; and
programming the computing system using the software instructions and audio/visual content items associated with the second event in response to receiving the user interaction with the second alert, the software instructions and audio/visual content items associated with the second event are different than the software instructions and audio/visual content items associated with the first event.

2. The method of claim 1, wherein:
the programming of the computing system using the software instructions and audio/visual content items associated with the first event in response to receiving the user interaction with the first alert comprises displaying a menu of options configured by the software instructions associated with the first event, each of the options corresponds to a function to be performed as configured by the software instructions associated with the first event.

3. The method of claim 1, wherein:
the audio/visual content items associated with the first event are of a different medium than the audio/visual content items associated with the second event.

4. The method of claim 1, wherein:
the program depicts a live occurrence; and
the timing of the first event and the second event are not known before the live occurrence.

5. The method of claim 1, wherein:
the event data associated with the program includes event data for the first event and event data for the second event;
the event data for the first event includes the software instructions and audio/visual content items associated with the first event;
the event data for the second event includes the software instructions and audio/visual content items associated with the second event;
the event data for the first event further includes a temporal identifier that indicates when the first event occurs during the program;
the event data for the second event further includes a temporal identifier that indicates when the second event occurs during the program; and
the temporal identifier that indicates when the first event occurs during the program and the temporal identifier that indicates when the second event occurs during the program are received at the computing system after starting the displaying of the program.

6. The method of claim 1, further comprising:
dynamically generating event data for the first event by the computing system while displaying the program, the event data for the first event includes the software instructions and audio/visual content items associated with the first event.

7. The method of claim 1, wherein:
event data includes a hierarchy of sets of event data;
the identifying event data associated with the program comprises determining which portion of the hierarchy of sets of event data is associated with the program.

8. The method of claim 1, wherein the event data includes a multiple sets of event data, the identifying event data associated with the program comprises:
identifying a user interacting with the computing system;
accessing user profile information for the user; and
filtering the multiple sets of event data based on the user profile information and information in the sets of event data, the identified event data associated with the program is the result of the filtering.

9. The method of claim 1, wherein the event data includes a multiple sets of event data, the identifying event data associated with the program comprises:
filtering the multiple sets of event data based on any of device capabilities, time of day, season, date, physical location, IP address, and default language settings.

10. The method of claim 1, wherein the identifying event data associated with the program comprises:
accessing event data in a common stream with the program;
accessing event data stored on the computing system prior to receiving the common stream with the program; and
obtaining event data from a remote location via network communication outside of the common stream with the program.

11. The method of claim 1, further comprising:
programming a wireless device, separate from the computing system, based on the software instructions and audio/visual content items associated with the first event in response to receiving the user interaction with the first alert.

12. The method of claim 1, further comprising:
identifying a first user interacting with the computing system;
accessing user profile information for the first user;
identifying a second user interacting with the computing system;
accessing user profile information for the second user;
programming a first companion electronic device, separate from the computing system, based on the software instructions associated with the first event and the user profile information for the first user; and
programming a second companion electronic device, separate from the computing system, based on the software instructions associated with the first event and the user profile information for the second user.

13. The method of claim 1, wherein:
the first alert is a visual display;
the user interaction with the first alert includes a physical gesture;
the computing system includes a depth camera;
the programming of the computing system using the software instructions and audio/visual content items associated with the first event in response to receiving the user interaction with the first alert includes automatically recognizing the gesture using the depth camera.

14. A computing system, comprising:
non-volatile storage that stores code;
a video interface;
a communication interface; and
a processor in communication with the non-volatile storage, the video interface and the communication interface;
a portion of the code programs the processor to access content and event data for a plurality of events that are associated and time synchronized with the content, the content is displayed via the video interface, the processor displays a linear time display that indicates a temporal location in the content and adds event indicators on the linear time display identifying time in the content for each event, the processor plays the content and updates the linear time display to indicate current temporal location of the content, when current temporal location of the content is equivalent to a temporal location of a particular event indicator then the processor provides a visible alert for the particular event associated with the particular event indicator, if the processor does not receive a response to the visible alert then the processor removes the visible alert without providing additional content associated with the visible alert, if the processor receives the response to the visible alert then the processor runs software instructions associated with the visible alert identified by event data associated with the particular event indicator, running the software instructions associated with the visible alert includes providing choices to perform any one of a plurality of functions.

15. The computing system of claim 14, wherein:
the software instructions and a portion of the content are received by the computing system via the communication interface while the content is displayed via the video interface.

16. The computing system of claim 14, wherein:
the software instructions associated with the visible alert identified by event data associated with the particular event indicator is different than software instructions associated with a different alert identified by event data associated with a different event indicator.

17. One or more processor readable storage devices having processor readable code stored thereon, the processor readable code for programming one or more processors to perform a method comprising:
identifying two or more users concurrently interacting with a first computing system;
accessing and displaying an audio/visual program using the first computing system;
identifying event data associated with the audio/visual program, the event data includes data for a plurality of events, the data for the events includes references to software instructions and audio/visual content items;
automatically determining that an event has occurred;
sending a first set of instructions to a second computing system based on user profile data associated with one of the two or more users identified to be concurrently interacting with the first computing system, the first set of instructions provide for the second computing system to display first content; and
sending a second set of instructions to a third computing system based on user profile data associated with another of the two or more users identified to be concurrently interacting with the first computing system, the second set of instructions provide for the third computing system to display second content different than the first content.

18. One or more processor readable storage devices according to claim 17, wherein:
the identifying two or more users concurrently interacting with the first computing system is performed automatically.

19. One or more processor readable storage devices according to claim 17, wherein:
the first computing device is an entertainment console associated with a video monitor;
the second computing device is a portable computing device; and
the third computing device is a portable computing device.

20. One or more processor readable storage devices according to claim 19, wherein:
the first content is a first set of functions;
the second content is a second set of functions that is different than the first set of functions;
the first set of functions is chosen based on the user profile data associated with one of the two or more users identified to be concurrently interacting with the first computing system; and
the second set of functions is chosen based on the user profile data associated with the another of the two or more users identified to be concurrently interacting with the first computing system.
